(19) United States
(12) Patent Application Publication
(10) Pub. No.: US 2014/0026868 A1
(43) Pub. Date: Jan. 30, 2014

(54) ADSORBED NATURAL GAS FUEL SYSTEM FOR HYBRID MOTOR VEHICLES

(71) Applicant: BASF Corporation, Florham Park, NJ (US)

(72) Inventors: William Dolan, Yardley, PA (US); Michael Santamaria, Monmouth Junction, NJ (US); Adam Cyril Lack, New York, NY (US)

(73) Assignee: BASF Corporation, Florham Park, NJ (US)

(21) Appl. No.: 13/947,867

(22) Filed: Jul. 22, 2013

Related U.S. Application Data
(60) Provisional application No. 61/675,039, filed on Jul. 24, 2012.

(51) Int. Cl. F02D 19/06; B67D 7/04

(52) U.S. Cl. CPC F02D 19/0647; F02D 19/0663; B67D 7/04
USPC 123/525; 141/4

(57) ABSTRACT

Disclosed are methods and systems for fueling hybrid vehicles by placing as part of the vehicle fuel system a tank containing a natural gas adsorbent where the natural gas is initially stored in said tank at a pressure of 700 psia or less.

### CROSS-REFERENCE TO RELATED APPLICATIONS

This application claims priority to U.S. Provisional Application No. 61/675,039, filed Jul. 24, 2012, the entire disclosure of which is hereby incorporated by reference herein.

### BACKGROUND

Natural gas, compressed natural gas (CNG) is a cleaner alternative to other fossil fuels for vehicles. Despite the cost advantage of natural gas compared to gasoline, natural gas powered automobiles have made limited inroads in the vehicle market—primarily in vehicle fleets where driving distance is limited and central filling stations make it convenient and economical. Wider adoption of natural gas as a fuel for non-fleet vehicles is restrained by a lack of fueling infrastructure, or in other words, there is a distribution problem with natural gas fueling. This has been also referred to in the industry as a chicken and egg problem. There are no CNG cars because there is no fueling infrastructure and there is no fueling infrastructure because there are no CNG powered cars. A lack of fueling infrastructure creates two problems for the vehicle owner. First, it may not be possible to fuel the car in the vicinity of the vehicle owner's home. Second, the vehicle owner will be stranded if the vehicle is driven too far from a fueling source, which is sometimes referred to as range anxiety. In addition, current CNG vehicles have a limited driving range because of the inherent lower fuel density of CNG relative to gasoline (CNG is approximately ⅓ the fuel density of gasoline). To solve the range anxiety issue, bi-fuel cars have been introduced by major automobile manufacturers. Bi-fuel vehicles allow for fueling the engine on natural gas for a period of time and then switching to gasoline for longer trips, however; the range on CNG for a bi-fuel vehicle is generally less than a vehicle that is fueled exclusively by CNG. Consequently, the distribution problem is only exacerbated as there is a shorter driving range between fillings of the CNG tank in the bi-fuel car. Consequently, if the bi-fuel car owner wanted to take advantage of cheap natural gas, then they would have to fill up more often and thus require even more potential filling stations. In addition the bi-fuel CNG must be filled at a higher frequency to take advantage of lower cost natural gas, making use of CNG inconvenient.

CNG is typically stored in steel or composite containers at high pressure (3000 to 4000 psi, or 205 to 275 bar). The CNG fuel tank is larger and more costly than a conventional gasoline fuel tank. Fueling stations for CNG cars are distinct from gasoline and diesel stations because CNG stations dispense high pressure gas. CNG stations must be sized and designed to accommodate the fuel demand and pattern of the vehicles that will fuel at the sites. They include unique components such as gas dryers and high pressure storage systems and are built to conform to codes specially developed for high pressure gas. It would be desirable to provide solutions to the distribution problem to enable CNG to be adopted as a primary fuel for vehicles.

### SUMMARY

Embodiments of the invention incorporate a natural gas compressor(s) into a vehicle to compress uncompressed natural gas into a tank containing a natural gas adsorbent.

A first embodiment of the invention is directed to a bi-fuel vehicle comprising an internal combustion engine powered by both gasoline fuel and natural gas fuel supplied at a minimum natural gas rail pressure. A natural gas tank contains a natural gas adsorbent located on the vehicle. The natural gas tank is full at a natural gas pressure in the range of 100 to 700 psia. The natural gas adsorbed on the adsorbent and the natural gas tank are in flow communication with the engine by a natural gas fuel line. A gasoline tank contains gasoline in flow communication with the engine by a gasoline fuel line. A control system regulates the flow of the gasoline and the natural gas to the engine. A compressor is in flow communication with the natural gas tank and the natural gas fuel line. The compressor maintains pressure of the natural gas at or above the minimum natural gas rail pressure when the engine is running.

A second embodiment further comprises a natural gas fill line in flow communication with the natural gas tank and the compressor.

In a third embodiment, the first or second embodiment is modified, wherein the natural gas tank contains a quantity of natural gas to provide a range of operation of the vehicle of 100 miles or less.

In a fourth embodiment, the first through third embodiments are modified, wherein the natural gas tank contains a quantity of natural gas to provide a range of operation of the vehicle of 50 miles or less.

In a fifth embodiment, the first through fourth embodiment are modified, wherein the control system comprises a switch control module that changes fuel supplied to the engine from natural gas fuel to gasoline fuel.

In a sixth embodiment, the fifth embodiment is modified, wherein the control system comprises a sensor that sends a signal to the control system to activate the switch control module based on a predetermined event.

In a seventh embodiment, the sixth embodiment is modified, wherein the predetermined event includes rapid acceleration of the vehicle.

In an eighth embodiment, the sixth embodiment is modified, wherein the predetermined event includes a low pressure threshold value.

In a ninth embodiment, the second through eighth embodiments are modified, wherein the control system includes a fill control module in communication with a fill pressure sensor to control pressure of the natural gas tank during filling of the tank.

In a tenth embodiment, the ninth embodiment is modified, wherein the control system includes a run control module in communication with a run pressure sensor and the compressor to control pressure of the natural gas during running of the engine.

In an eleventh embodiment, the tenth embodiment is modified, wherein the natural gas tank is full in the range of 150 psia to 500 psia.

In a twelfth embodiment, the second through eleventh embodiments are modified, wherein the fill compressor is on board the vehicle.

In a thirteenth embodiment, the second through twelfth embodiments, wherein the natural gas tank can be refilled by connection of the fill line to a conventional home natural gas line.

A fourteenth embodiment is directed to methods of fueling a bi-fuel vehicle including a gasoline tank and a natural gas tank containing a natural gas adsorbent. A gas supply is connected to a fill line on the vehicle in flow communication with the natural gas tank and a compressor. The natural gas tank is filled to a pressure of 700 psia or less.

In a fifteenth embodiment, the fourteenth embodiment is modified, wherein the pressure is 500 psia or less.

In a sixteenth embodiment, the fourteenth and fifteenth embodiments are modified, wherein the at least one compressor is located on the vehicle which allows for the addition of a low pressure source of natural gas to the tank containing an adsorbent and allows for the pressurization of the tank to the desired pressure.

In a seventeenth embodiment, the sixteenth embodiment is modified, wherein the compressor is mechanically or electrically powered by the vehicle.

In an eighteenth embodiment, the sixteenth embodiment is modified, wherein the compressor can be powered by electricity when the car engine is not running.

In a nineteenth embodiment, the eighteenth embodiment is modified, wherein the electricity is provided by a battery.

In a twentieth embodiment, the fourteenth through nineteenth embodiments are modified, wherein a regulator is used to control delivery of pressured gas from the adsorbent tank to the engine while the engine is running.

In a twenty-first embodiment, the fourteenth through twentieth embodiments are modified, wherein upon filling, the natural gas tank contains a quantity of natural gas that allows the car to run no more than 100 miles.

In a twenty-second embodiment, the first through twenty-first embodiments, are modified, wherein the adsorbent is selected from the group consisting of activated carbons, zeolites, metal organic frameworks and mixtures thereof.

A twenty-third embodiment is directed to methods of operating a bi-fuel vehicle including a gasoline tank and a natural gas tank containing a natural gas adsorbent. A gas supply is connected to a fill line on the vehicle in flow communication with the natural gas tank and a compressor. The natural gas tank is filling with natural gas to a pressure of 700 psia or less. The vehicle powered by the natural gas is driven for a limited range of less than 100 miles, reducing the pressure in the tank. The natural gas tank is refilled by repeating the first step.

In a twenty-fourth embodiment, the twenty-third embodiment is modified, wherein the pressure in the natural gas tank drops to a value in the range of about 5 psia to about 20 psia before refilling the natural gas tank.

### BRIEF DESCRIPTION OF THE DRAWINGS

FIG. 1 is a schematic representation of a bi-fuel vehicle according to an embodiment of the invention;

FIG. 2 shows the vehicle of FIG. 1 in a natural gas fueling mode;

FIG. 3 shows the vehicle of FIG. 1 running on natural gas fuel; and

FIG. 4 shows the vehicle of FIG. 1 running on gasoline.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

Compressed natural gas (CNG) can be stored at lower pressure as Adsorbed Natural Gas (ANG) in a tank at 35 bar (500 psi), when the CNG is absorbed on various materials, including activated carbon and metal-organic frameworks (MOFs). The fuel is stored at similar or greater energy density than CNG. A benefit of storing fuel in this manner is that vehicles can be refuelled from the natural gas network without extra gas compression. Furthermore, the fuel tanks can be slimmed down and made of lighter materials that are lower in strength.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items

The term “zeolites” refers to hydrated aluminosilicate minerals having a micro-porous structure and includes both natural and synthetic types.

The phrase “metal-organic frameworks” refers to crystalline compounds consisting of metal ions or clusters coordinated to often rigid organic molecules to form one-, two-, or three-dimensional structures that can be porous.

The phrase “natural gas” refers to gas produced from petroleum wells or by anaerobic digestion of organic material whose composition is predominantly methane, CH₄, but which can contain other hydrocarbons.

The phrase “activated carbon” refers to a form of carbon having very fine pores, which is used chiefly for adsorbing gases or solutes, as in various filter systems for purification, deodorization, and decolorization.

The term “tank” refers to a receptacle, container, or structure for holding a liquid or a gas.

The term “vehicle” or “vehicles” refers to all forms of mobile transportation including automobiles, trucks, forklifts, and motorcycles.

The following abbreviations are used: psia pressure in pounds per square inch atmospheric BET Brunauer-Emmett-Teller (BET) theory CNG Compressed natural gas MOFs Metal-Organic Frameworks.

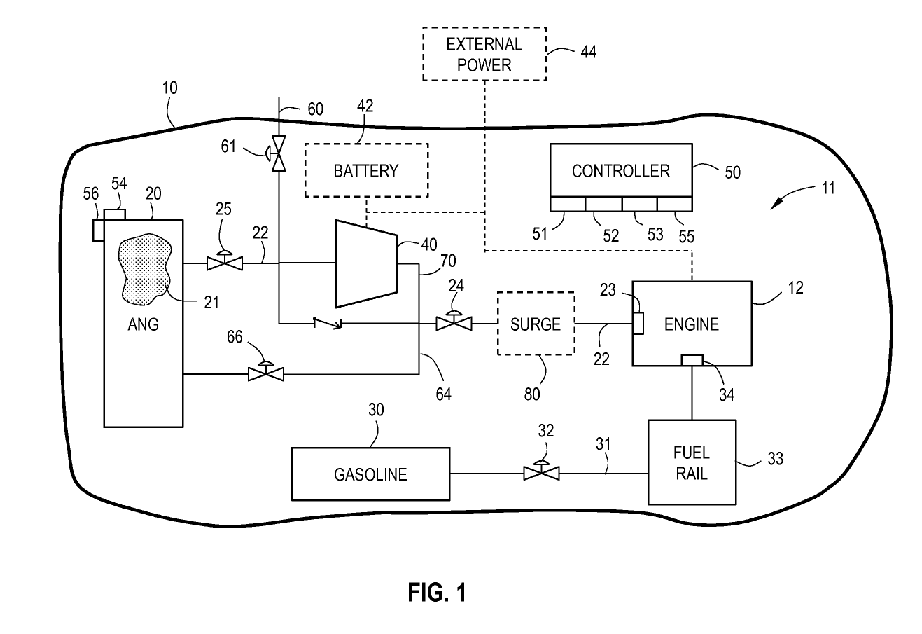

FIG. 1 is a schematic representation of a bi-fuel vehicle 10 with a bi-fuel system 11 in accordance with one or more embodiment of the invention. The vehicle 10 includes an internal combustion engine 12 which can be powered by gasoline fuel and/or natural gas fuel supplied at a minimum natural gas rail pressure. Accordingly, the vehicle 10 includes a natural gas tank 20 and a gasoline tank 30.

The natural gas tank 20 is in flow or fluid communication with the engine 10 via a natural gas fuel line 22. The natural gas fuel line 22 shown in the Figures has multiple segments with various engine components (e.g., valves). While individual segments of the fuel line will be referred to separately, it will be understood by those skilled in the art that the natural gas fuel line refers to the entire path through which natural gas flows from the natural gas tank 20 to the combustion engine 12.

The natural gas tank 20 contains a natural gas adsorbent 21 to safely store the natural gas. The natural gas tank 20 can be charged with natural gas to a desired pressure for vehicle operation. In some embodiments, the natural gas tank 20 can be charged to a pressure in the range of about 100 psia to about 700 psia, or in the range of about 150 psia to about 650 psia, or in the range of about 200 psia to about 600 psia, or in the range of about 250 psia to about 550 psia. In operation, the natural gas tank 20 can supply natural gas to the combustion engine 12 until the natural gas pressure in the natural gas tank 20 decreases to about 5 psia. In some embodiments, the natural gas pressure in the natural gas tank 20 can be decreased to a pressure in the range of about 5 psia to about 20 psia. A fuel control valve 24 can be opened/closed to ensure that there is a sufficient flow of natural gas to the cylinders.

The sorbent material can be any suitable material capable of storing and releasing natural gas. In some embodiments, the adsorbent is selected from the group consisting of activated carbons, zeolites, metal organic frameworks and mixtures thereof.

Activated carbons useful with embodiments of the invention include Norit R 1 Extra, BPL, Maxsorb, A10 Fiber and Activated Carbon A all of which are described and their ability to adsorb methane in Himeno, S; Komatsdsu, T and Fujita, S; High-Presure Adsorption of Methane and Carbon Dioxide on Several Activated Carbons; J. Chem. Eng. Data 2005, 50, 369-376 which is incorporation by reference for its disclosure of activated carbons suitable for use in methane adsorption.

Examples of suitable adsorbents include metallo-organic frameworks and other adsorbent materials. For example, metallo-organic framework materials as such are described, for example, in. U.S. Pat. No. 5,648,508, EP-A-0 709 253, M. O'Keeffe et al., J. Sol. State Chem., 152 (2000) p. 3-20, H. Li et al., Nature 402 (1999) p. 276 seq., M. Eddaoudi et al., Topics in Catalysis 9 (1999) p. 105-111, B. Chen et al., Science 291 (2001) p. 1021-23 and U.S. Pat. No. 7,309,380. Other suitable adsorbent materials and methods for their preparation are disclosed in WO 02/088148. The content of these publications, to which reference is made herein, is fully incorporated in the content of the present application as they relate to metal organic frameworks useful in this invention.

During operation, the natural gas is flowed from the natural gas tank 20 through the natural gas fuel line 22 to the combustion engine 12. One or more natural gas fuel injectors 23 may be included in the combustion engine 12 to inject natural gas into the engine cylinders (not shown). The natural gas fuel injectors 23 can inject the gas into the cylinders at any suitable pressure for combustion. For example, the natural gas fuel injectors 23 can introduce the natural gas to the cylinders at a pressure greater than about 35 psia or a pressure up to about 90 psia.

The amount of natural gas held by the natural gas tank 20 can have a significant impact on the operation of the vehicles. The more natural gas is stored, the longer the engine can run on natural gas. However, more natural gas storage may result in a heavier vehicle or require a large natural gas storage tank 20. In some embodiments, the natural gas tank 20 contains a quantity of natural gas to provide a range of operation of the vehicle 10 of about 100 miles or less. In one or more embodiments, the natural gas tank 20 holds enough natural gas to provide a range of operation of the vehicle 10 of about 90 miles or less, or about 80 miles or less, or about 70 miles or less, or about 60 miles or less, about 50 miles or less, about 45 miles or less, about 40 miles or less or about 35 miles or less. The natural gas tank 20 may be considered to be full when the pressure of natural gas in the tank is in the range of about 150 psia to about 500 psia, or in the range of about 150 psia to about 400 psia, or in the range of about 150 psia to about 300 psia, or in the range of about 150 psia to about 250 psia.

The bi-fuel system 11 includes a gasoline tank 30 which, as will be known to those skilled in the art, can be used to store gasoline. The gasoline tank 30 can contain a quantity of gasoline the provides a greater range for driving than the natural gas. For example, the gasoline tank may contain a quantity of gasoline that allows the vehicle to travel 450, 400, 350 or 300 miles, which will of course depend on the fuel efficiency of the vehicle and the size of the gasoline tank. The gasoline tank 30 is in flow or fluid communication with the combustion engine 12 through a gasoline fuel line 31. A gasoline flow valve 32 may be positioned along the gasoline fuel line 31 to allow or prevent the flow of gasoline from the gasoline tank 30 to the engine 12. For example, the gasoline flow valve 32 may be closed to prevent gasoline from flowing to the combustion engine 12, forcing the engine to operate on natural gas only. Other components, shown generically as component 33, may also be positioned along the gasoline fuel line 31 for a variety of purposes. For example, component 33 may be incorporated to maintain adequate flow, measure and control the flow, or split the flow to multiple fuel injectors 34 within the combustion engine 12.

The system 11 includes a compressor 40 in flow communication with the natural gas tank 20 and natural gas fuel line 22. The compressor 40 maintains the pressure of the natural gas at or above the minimum natural gas rail pressure when the engine 12 is running. The compressor 40 can be any suitable compressor which is capable of maintaining the natural gas rail pressure. For example, a 1.6 horsepower (hp) compressor may be capable of providing a flow of gas about 5 scfm with max delivery pressure of about 150 psia. A minimum natural gas rail pressure is any pressure higher than the suction of the compressor or any pressure sufficient to operate the vehicle.

Many types of compressor can be considered for application, among them are rotary, scroll and reciprocating. In addition hermetically sealing or the compressor can also be considered to reduce the potential for natural gas leakage from the compressor as is done in many air conditioning and refrigeration systems.

In a typical scenario, a car travels at 60 mph on a highway, and under these conditions, the car has a fuel efficiency of 30 mpg, the car will consume 2 gallons every hour or 1 gallon every 30 minutes. Assuming 138 standard cubic feet (scf) of natural gas in a gallon of gas equivalent provides a flowrate of natural gas of 4.6 scf per minute. Further, if the natural gas tank is at a pressure of 15 psia and the compressor must deliver natural gas to the engine at 150 psia, then the compressor would need a motor of about 1 hp. Accordingly, compressors with motors of 3 hp, 2.5 hp, 2 hp, 1.5 hp and 1 hp can be used according to one or more embodiments of the invention.

While the above compressors are suitable for normal driving, vehicles encounter higher loads when accelerating or climbing hills, which can require the flow to increase by a factor of six. In this case, the compressor may require up to 6 hp of power and may be required to deliver up to 30 scfm of natural gas. Thus, according to one or more embodiments, the compressor may be sized for vehicles driving under high loads, or alternatively, the vehicle may include a second or high load compressor (not shown). Another alternative for the bi-fuel vehicle to operate under high loads is to use a surge tank, or to switch to operation by gasoline fuel, which is discussed further below.

The system 11 also includes a control system 50 to regulate the flow of gasoline and natural gas to the engine 12. For clarity purposes, in the Figures, the control system 50 is not connected to any of the components. However, it will be understood by those skilled in the art that the control system 50 is connected, in some manner, to most if not all of the components of the system. This connection between the control system 50 and the individual components can be wired or wireless. The control system 50 can include a computer programmed to operate any or all of the engine functions. Additionally, the control system 50 can be made up of a plurality of individual sub-controllers (not shown) linked to a central controller. The control system 50 can be integrated with the vehicle's other control systems and on board diagnostics in the usual way.

The control system 50 may include a switch control module 51 that changes the fuel supplied to the engine 11 from natural gas fuel to gasoline fuel. The switch control module 51 may be hardware, software or a combination of hardware and software capable of changing the fuel composition entering the engine 12. The switch control module 51 may close the natural gas flow valve 25 along the natural gas fuel line 22 to prevent natural gas flowing to the engine 12 while opening the gasoline flow valve 32 to allow the flow of gasoline fuel to the engine 12. The switch control module 51 may also open and close other switches and valves within the system 11.

The control system 50 may also include one or more sensors 52. The sensors can be any suitable sensor depending the specific component or system being monitored. For example, the sensor 52 can include pressure sensors, flow sensors, temperature sensors, acceleration sensors. In some embodiments, the sensors 52 are capable of sending a signal to the control system 50 which can activate, for example, the switch control module 51, in response to a specific stimulus or a predetermined event. Events that may trigger the control system include, but are not limited to, rapid acceleration of the vehicle 10 and low pressure of the natural gas tank 20.

The control system 50 may also include a fill control module 53 in communication with a fill pressure sensor 54 to control the pressure of the natural gas tank 20 during filling of the tank. The fill control module 53 and the fill pressure sensor 54 can be used in conjunction to ensure that the natural gas tank 20 is properly filled, or pressurized, to allow for vehicle to obtain maximum mileage from the natural gas. Similarly, the control system 50 may also include a run control module 55 in communication with a run pressure sensor 56 and the compressor 40 to control the pressure of the natural gas during running of the engine 12. The fill control module 53 and fill pressure sensor 54 can be the same components as the run control module 55 and the run pressure sensor 56, or they can be different components. For example, the fill control module 53 and run control module 55 can be software (including firmware) based systems that perform different tasks using the same hardware (i.e., pressure sensor) that is used to measure fill pressure and run pressure.

In some embodiments, the system 11 includes a natural gas fill line 60 which extends from, or is accessible from outside the body of the vehicle 10. This allows a user to connect a natural gas source to the natural gas fill line 60 to recharge the natural gas tank 20. The natural gas fill line 60 is in flow communication with the natural gas tank 20 and the compressor 40. In some embodiments, the fill compressor can be the same compressor 40 used to cause the natural gas to flow to the engine or can be a separate compressor (not shown) whose primary function is to fill the natural gas tank 20. The fill compressor can be on board the vehicle 10 so that it remains in a fixed position relative to the natural gas tank 20, or can be unit separate from the vehicle.

In one or more embodiments, the fill compressor is a separate component from the vehicle 10, like a portable compressor unit or a fixed mounted compressor. For example, a user may have a permanent compressor located within their residence which can be used to recharge the natural gas tank 20 while the vehicle 10 is parked at the residence. In this scenario, the natural gas tank 20 can be refilled by connection of the fill line 60 to a conventional home natural gas line.

The system described above provides a vehicle that can be easily and readily re-fueled at the home or residence of the driver or owner of the vehicle. Such a vehicle provides a major advance in solving the infrastructure and distribution problems that have plagued the implementation of CNG vehicles. Consumers and homeowners that have natural gas supplies to their homes can simply refuel the CNG in their vehicle by plugging in a convention gas line, which can be supplied from any natural gas line, and any suitable connections such as a hose, a quick connection (such as the type used on gas grills) and/or a regulator. With the supply and infrastructure problem addressed, CNG powered bi-fuel vehicles can be more widely manufactured and used.

To illustrate benefits of one or more embodiments of the invention, consider that a conventional gasoline car with a 30 mpg fuel rating and a 15 gallon tank is defined as a reference case. The car has a range of 450 miles. Seventy percent of the US drives 40 miles or less per day, which means 70% or less of cars would need tank filled at least once every 11 days if they had a 30 mpg fuel rating.

A car running on compressed natural gas with a 15 gallon tank compressed to 3600 psia would hold 5.2 gasoline equivalent gallons. A car with a 30 mile per gallon rating with this tank would have a range of 155 miles. Seventy percent of the US drives 40 miles or less per day, which means 70% or less of cars would need tank filled at least once every 4 days if the cars have a 30 mpg fuel rating and were using CNG. Currently there is minimal fueling infrastructure in the US for CNG cars, and thus it would be difficult to refuel this car at such a frequency.

Using the fueling infrastructure for CNG can be in part eliminated by installing a compressor at the house. However, the cost to buy and install the CNG compressor at the house is approximately 5000-7000 US dollars. This would allow the user to fill their car for local everyday commuting. However, with only CNG as a fuel a long trip with this car would be problematic as there is very few natural gas fueling stations. Embodiments of the present invention reduce and/or eliminate the aforementioned problems.

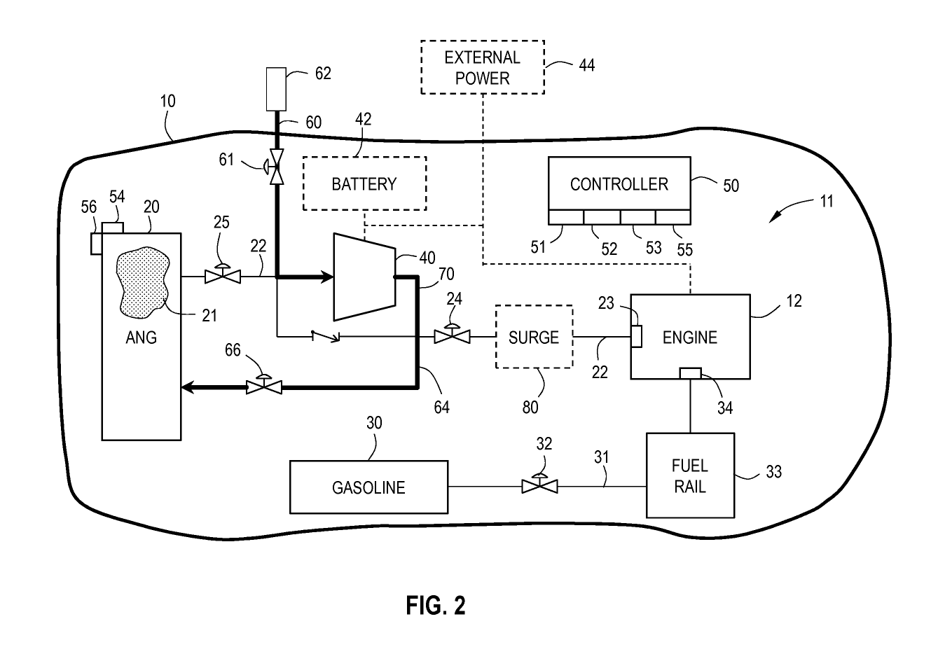

FIG. 2 shows a bi-fuel vehicle 10 of one or more embodiments in which the natural gas tank 20 is being filled with natural gas. The vehicle 10 can be put into this configuration by any suitable means including manually through some type of user controlled mechanism or automatically in response to some stimulus. In a manual method, the user may press a button or switch located within the cabin of the vehicle or near the fill line 60 which notifies the control system 50 that the vehicle is about to be filled with natural gas. Alternately, the connection of a natural gas source to the vehicle can trigger a signal to the control system 50. In response to the trigger, the control system 50 causes the fuel control valve 24 and the natural gas control valve 25 to close and the fill valve 66 to open. This prevents natural gas from being drawn from the natural gas tank 20 or entering the engine 12 while allowing natural gas to flow into the natural gas tank 20.

In the embodiment shown in FIG. 2, a natural gas supply 62 is connected to the fill line 60 of the vehicle 10. The fill line 60 is in fluid communication with the natural gas tank 20 and a compressor 40 as indicated by the bold route shown. The natural gas flows through the fill line 60 either drawn by compressor 40 or pushed by the pressure in the gas supply 62 or an external compressor. The natural gas is shown flowing through the compressor 40 to a fuel line 70, which is a leg of fuel line 22, through the fill valve 66 and into the natural gas tank 20 where the natural gas is adsorbed onto the adsorbent material within. The natural gas tank 20 is filled to any suitable pressure, as described above. In some embodiments, the natural gas pressure in the natural gas tank 20 is filled to less than about 700 psia, or less than about 500 psia or less than about 300 psia.

The compressor used to fill the natural gas tank 20 can be located on the vehicle, as shown in the Figures as compressor 40. This allows for the addition of low pressure natural gas to the natural gas tank 20 and proper pressurization of the tank to the desired pressure. The compressor 40 can be powered by different sources with each shown in phantom lines in the Figures. In some embodiments, the compressor 40 is mechanically or electrically powered by the engine 12 through, for example, an alternator or the on board battery. To accomplish this, the engine can be either running on gasoline or not running.

In some embodiments, a second battery 42 is located on the vehicle to power the compressor 40. This battery 42 can be located remotely from the engine 12 and may only be used for natural gas filling purposes. The battery 42 can be recharged by the engine 12 during normal vehicle operation and can provide sufficient power to run the compressor long enough to completely fill the natural gas tank 20.

In some embodiments, the compressor 40 is powered during filling by an external power source 44. This can be an external battery or a house power line. For example, a dual power/gas line can be connected to the fill line 60 and configured to power the compressor 40 at the same time.

During filling, the fill control module 53 communicates with the fill pressure sensor 54 to evaluate the state of the natural gas tank 20. When the fill pressure sensor 54 and fill control module 53 detect that the natural gas tank 20 is full, the control system 50 can stop the fill by any or all of closing the fill valve 66, turning of the compressor 40 or shutting a fill line valve 61 to prevent additional natural gas from entering the vehicle. In some embodiments, the natural gas supply 62 can be controlled by control system 50, and can be automatically turned off when the natural gas tank 20 is full.

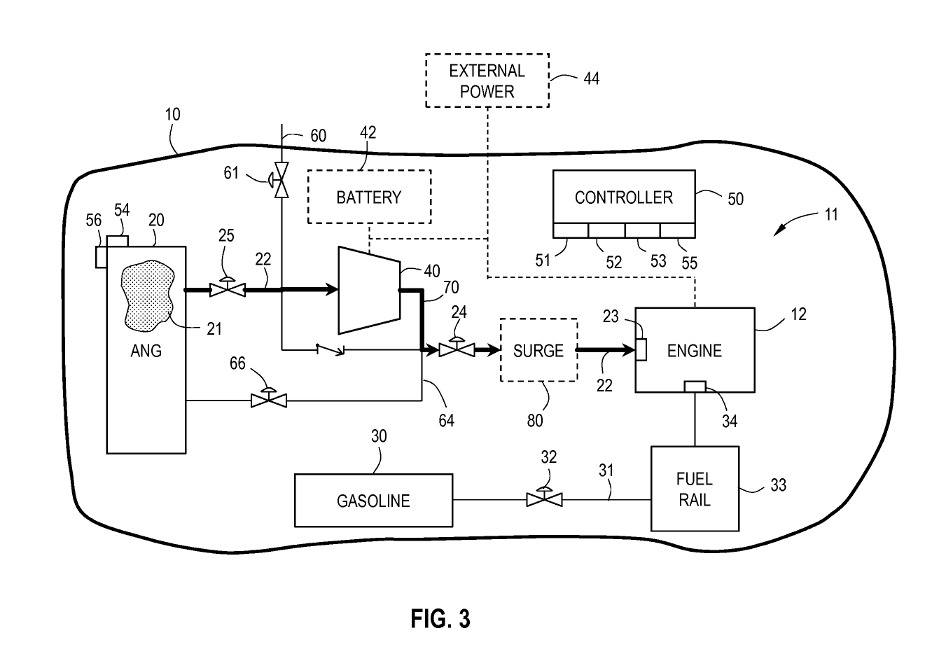

FIG. 3 shows an embodiment of the invention in which the vehicle 10 is operating on adsorbed natural gas. Here, the control system 50 sends a signal to open natural gas flow valve 25 and fuel control valve 24 creating a fluid communication between the natural gas tank 20 and the engine 12. The natural gas can desorb from the adsorbent in the natural gas tank 20, flow through the natural gas flow valve 25 and compressor 40. The control system 50 can monitor and control the compressor to ensure that the proper amount of natural gas is passed to the engine 12. The natural gas exiting the compressor 40 flows through the fuel line 70 and fuel control valve 24 into the engine 12. In some embodiments, the control system 50 adjusts a regulator to control the delivery of pressurized gas from the natural gas tank 20 to the engine 12 while the engine is running. The regulator can be incorporated into the fuel control valve 24, or a separate component along natural gas fuel line 22.

An optional surge tank 80 may be positioned in flow communication with the natural gas fuel line 22 between the fuel control valve 24 and the engine 12. Without being bound by any particular theory of operation, it is believed that the surge tank 80 may provide sufficient storage capacity for natural gas such that for short periods of time (30 seconds or less) such that a compressor would not have to be dramatically oversized to handle the additional fuel requirements associated with higher fuel demands of acceleration. The surge tank 80 may include additional adsorbent material, which can be the same sorbent as the natural gas tank 20 or a different sorbent. In either case the adsorbent would hold additional capacity relative to an empty tank

The vehicle 10 can be driven on natural gas for a limited range. In some embodiments, the range is less than about 100 miles. During this period the pressure in the natural gas tank 20 decreases. When the pressure reaches a predetermined level, as measured by the run pressure sensor 56 and communicated to the run control module 55, the control system 50 can switch the system 11 to gasoline power. In some embodiments, the run pressure sensor 56 and run control module 55 will not trigger the control system 50 to switch to gasoline until the pressure in the natural gas tank 20 has dropped to a value in the range of about 5 psia to about 20 psia.

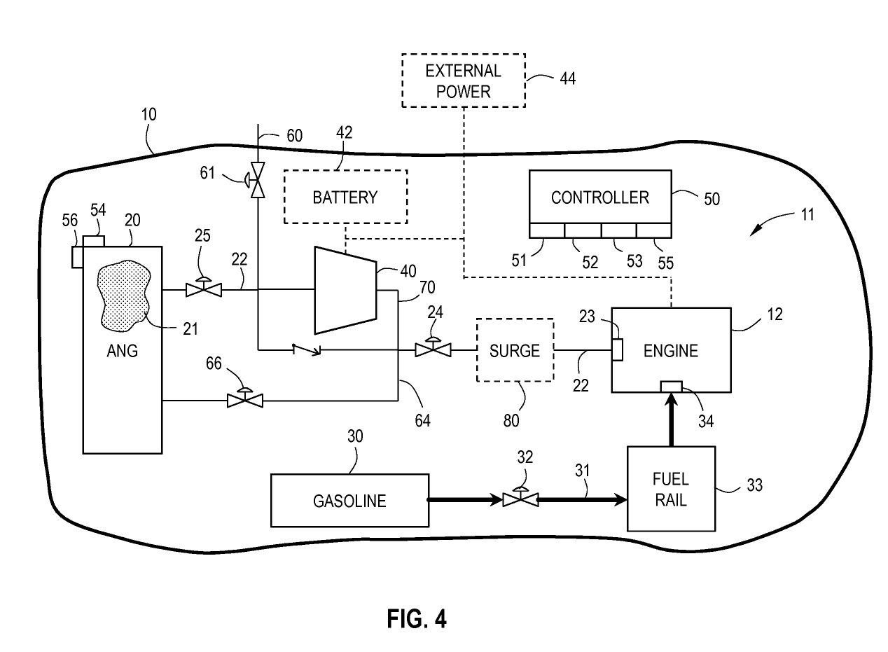

Referring to FIG. 4, the control system 50 can close the natural gas flow valve 25, turn off the compressor 40 and close the fuel control valve 24 to prevent additional natural gas from entering the engine 12. In some embodiments, only the natural gas flow valve 25 needs to be closed to prevent the natural gas tank 20 from becoming completely drained of natural gas, although it may be desirable to do so. The control system 50 opens gasoline flow valve 32 to allow gasoline from the gasoline tank 30 to flow through the gasoline flow valve 32 and the gasoline fuel line 31 into the engine 12. In some embodiments, as shown in the Figures, an optional fuel rail 33 is in fluid communication with the fuel line 31 upstream of the engine 12.

The transition from natural gas powered engine to gasoline powered engine can be abrupt or gradual. In some embodiments, the control system 50 opens and closes valves slowly so that there is a smooth transition between natural gas and gasoline entering the engine. This may result in the engine combusting a combination of natural gas and gasoline for a time.

The switch from natural gas to gasoline, or a combination fuel supply, can occur when the natural gas tank 20 is running low or when other conditions are experienced by the vehicle. For example, the switch control module 51 in conjunction with one or more sensors 52 may provide feedback to the control system 50 which indicates that more power is needed. This might occur when the vehicle 10 is travelling up a steep incline or accelerating quickly. During this period, the control system 50 can provide gasoline to the fuel mix or switch to gasoline to produce additional driving power. When the additional power is no longer needed, the control system 50 can then cut off the gasoline supply to the engine leaving only the natural gas supply.

Illustrative examples of possible bi-fuel vehicle configurations and operation are described below using carbon as a sorbent, but it should be understood that the sorbent according to the invention is not limited to carbon. The carbon in the examples below is described in “High-Pressure Adsorption Equilibria of Methane and Carbon Dioxide on Several Activated Carbons” J. Chem. Eng. Data 2005 50, 369-376. Table 4 gives pressure vs. wt. % adsorbed for the materials Maxsorb described in said paper. Based on the data as presented in this paper it is possible to estimate the amount of equivalent gasoline stored assuming ideal gas for void methane and assuming the tanks discharge isothermally. Both assumptions are approximations but nonetheless are indicative of actual equivalent gasoline stored.

In one example of a system, a 15 gallon adsorbed natural gas tank containing Maxsorb on a car is filled to 700 psia is then depressurized to 150 psia to deliver fuel to the engine. The adsorbed natural gas would have a gasoline equivalent of storage available of 0.95 gallons. A car with a 30 mpg rating would provide a 29 mile range on natural gas.

In another example of a system, a 15 gallon adsorbed natural gas tank containing Maxsorb on a car is filled to 700 psia and then depressurized to 15 psia to deliver fuel to the engine. However this would only work if the engine fuel could be supplied at close to atmospheric pressure as in a fuel system with a carbureted engine. The adsorbed natural gas would have a gasoline equivalent of storage available of 1.58 gallons. A car with a 30 mpg rating would provide a 48 mile range on natural gas.

In another example of a system, a 15 gallon adsorbed natural gas tank containing Maxsorb is placed on a car filled to 700 psia and then depressurized the to 15 psia to deliver fuel to a compressor on the car which then would supply natural gas to the engine at a higher pressure. Typical fuel pressure requirements are 80 to 120 psia. Elevated fuel pressures can be required for engine management requirements, such as emission control and acceleration, and improved fuel economy. The adsorbed natural gas would have a gasoline equivalent of storage available of 1.6 gallons. A car with a 30 mpg rating would have a 48 mile range on natural gas.

In another system example, a 15 gallon adsorbed natural gas tank containing Maxsorb is placed on a car and filled to 150 psia and then depressurized to 15 psia to deliver fuel to a compressor on the car which then would supply natural gas to the engine at a higher pressure. Typical fuel pressure requirements are 80 to 120 psia. Elevated fuel pressures are required for engine management requirements, such as emission control and acceleration, and improved fuel economy. The adsorbed natural gas would have a gasoline equivalent of storage available of 0.63 gallons. A car having a 30 mpg rating would provide a 19 mile range on natural gas.

In another example, a 15 gallon adsorbed natural gas tank containing Maxsorb on a car is filled to 250 psia and then depressurized to 15 psia to deliver fuel to a compressor on the car which then would supply natural gas to the engine at a higher pressure. Typical fuel pressure requirements are 80 to 120 psia. Elevated fuel pressures are required for engine management requirements, such as emission control and acceleration, and improved fuel economy. The adsorbed natural gas would have a gasoline equivalent of storage available of 0.9 gallons. A car having a 30 mpg rating would provide a 27 mile range on natural gas.

In another example, a 15 gallon adsorbed natural gas tank containing Maxsorb is placed on a car. Different Maxsorb particle sizes are used to enhance bulk density. Typical enhancements of 30% can be expected. Filling to 250 psia the tank with natural gas and then depressurizing the tank to 15 psia to deliver fuel to a compressor on the car which then would supply natural gas to the engine at a higher pressure. Typical fuel pressure requirements are 80 to 120 psia. Elevated fuel pressures are required for engine management requirements, such as emission control and acceleration, and improved fuel economy. The adsorbed natural gas would have a gasoline equivalent of storage available of 1.05 gallons. A car having a 30 mpg rating this would provide a 32 mile range on natural gas.

In another example, a 15 gallon adsorbed natural gas tank containing adsorbent is placed on a car. A low pressure natural gas source is attached to the car and to fill the adsorbed natural gas tank using compressor on the car to pressurize natural gas then fill adsorbed natural gas tank where the car engine is used to provide power to drive compressor.

In another example, a 15 gallon adsorbed natural gas tank containing adsorbent is placed on a car. A low pressure natural gas source is attached to the car and to fill the adsorbed natural gas tank using compressor on car to pressurize natural gas then fill adsorbed natural gas tank. A secondary electrical hookup can be provided to power compressor on car when car engine if off.

In another example, a smaller secondary tank at the discharge of the compressor is added to act as a surge volume for periods of rapid acceleration so the compressor on the car can be reduced in size.

In another example, a smaller secondary tank at the discharge of the compressor is added to act as a surge volume for periods of rapid acceleration so the compressor on the car can be reduced in size. The secondary tank contains adsorbent to enhance the capacity of the surge volume A secondary fuel such as gasoline is added to the car to give the car range, and allow for use of the existing liquid fueling infrastructure. Switching to secondary fuel such as gasoline during periods of rapid acceleration so the compressor on the car can be reduced in size.

Tables 1 through 4 below provide examples of various system configurations.

TABLE 1
Standard Packing

| | | | | |
|---|---|---|---|---|
| Volume Tank (gal) | 15 | 15 | 15 | 15 |
| Total void (ft³ void/ft³ | 0.65 | 0.65 | 0.65 | 0.65 |
| Tank) | | | | |
| Tank Pressure (psia) | 700 | 150 | 15 | 250 |
| methane Stored void (# | 0.16 | 0.04 | 0.00 | 0.06 |
| mole) | | | | |
| # mole methane on | 0.44 | 0.22 | 0.02 | 0.29 |
| adsorbent | | | | |
| Total methane stored # | 0.60 | 0.25 | 0.02 | 0.35 |
| mole | | | | |
| Total methane stored scf | 227.1 | 95.8 | 8.2 | 132.2 |
| Equivalent gallon | 1.64 | 0.69 | 0.06 | 0.96 |
| gasoline stored | | | | |

TABLE 2
Dense Packing (multiple size particles)

| | | | | |
|---|---|---|---|---|
| Volume Tank (gal) | 15 | 15 | 15 | 15 |
| Total void (ft3void/ | 0.35 | 0.35 | 0.35 | 0.35 |
| Ft3Tank) | | | | |
| Tank Pressure (psia) | 700 | 150 | 15 | 250 |
| methane Stored void (# | 0.09 | 0.02 | 0.00 | 0.03 |
| mole) | | | | |
| # mole methane on | 0.57 | 0.28 | 0.02 | 0.38 |
| adsorbent | | | | |
| Total methane stored # | 0.65 | 0.30 | 0.03 | 0.41 |
| mole | | | | |
| Total methane stored scf | 247.9 | 114.4 | 9.7 | 154.9 |
| Equivalentgallon | 1.80 | 0.83 | 0.07 | 1.12 |
| gasoline stored | | | | |

TABLE 3
Gallons Gas Equivalent Available

| | | Dense density |
|---|---|---|
| | | packing (multiple |
| | | size particles) |
| Working Pressure | Standard density packing | Gallons gas |
| Ranges | Gallons gas equivalent | equivalent |
| 700 psia to 150 | 0.95 | 0.97 |
| psia | | |
| 700 psia to 15 | 1.58 | 1.73 |
| psia | | |
| 150 psia to 15 | 0.63 | 0.76 |
| psia | | |
| 250 psia to 15 | 0.90 | 1.05 |
| psia | | |

TABLE 4
Maxsorb Carbon Adsorbent

| Pressure of Methane | Capacity (g CH₄/g adsorbent) |
|---|---|
| (psia) | (wt %) |
| 700.38 | 19.20% |
| 250.00 | 12.80% |
| 150.00 | 9.60% |
| 14.99 | 0.80% |

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A bi-fuel vehicle comprising:
an internal combustion engine powered by both gasoline fuel and natural gas fuel supplied at a minimum natural gas rail pressure;
a natural gas tank containing a natural gas adsorbent located on the vehicle, wherein the tank is full at a natural gas pressure in the range of 100 to 700 psia, the natural gas adsorbed on the adsorbent and the natural gas tank in flow communication with the engine by a natural gas fuel line;
a gasoline tank containing gasoline in flow communication with the engine by a gasoline fuel line;
a control system that regulates flow of the gasoline and the natural gas to the engine; and
a compressor in flow communication with the natural gas tank and natural gas fuel line that maintains pressure of the natural gas at or above the minimum natural gas rail pressure when the engine is running.

2. The bi-fuel vehicle of claim 1, further comprising a natural gas fill line in flow communication with the natural gas tank and the compressor.

3. The bi-fuel vehicle of claim 1, wherein the natural gas tank contains a quantity of natural gas to provide a range of operation of the vehicle of 100 miles or less.

4. The bi-fuel vehicle of claim 3, wherein the natural gas tank contains a quantity of natural gas to provide a range of operation of the vehicle of 50 miles or less.

5. The bi-fuel vehicle of claim 1, wherein the control system comprises a switch control module that changes fuel supplied to the engine from natural gas fuel to gasoline fuel.

6. The bi-fuel vehicle of claim 5, wherein the control system comprises a sensor that sends a signal to the control system to activate the switch control module based on a predetermined event.

7. The bi-fuel vehicle of claim 6, wherein the predetermined event includes rapid acceleration of the vehicle.

8. The bi-fuel vehicle of claim 6, wherein the predetermined event includes a low pressure threshold value.

9. The bi-fuel vehicle of claim 2, wherein the control system includes a fill control module in communication with a fill pressure sensor to control pressure of the natural gas tank during filling of the tank.

10. The bi-fuel vehicle of claim 9, wherein the control system includes a run control module in communication with a run pressure sensor and the compressor to control pressure of the natural gas during running of the engine.

11. The bi-fuel vehicle of claim 10, wherein the natural gas tank is full in the range of 150 to 500 psia.

12. The bi-fuel vehicle of claim 2, wherein the fill compressor is on-board the vehicle.

13. The bi-fuel vehicle of claim 2, wherein the natural gas tank can be refilled by connection of the fill line to a conventional home natural gas line.

14. A method of fueling a bi-fuel vehicle including a gasoline tank and a natural gas tank containing a natural gas adsorbent, the method comprising connecting a gas supply to a fill line on the vehicle, the fill line in flow communication with the natural gas tank and a compressor and filling the natural gas tank to a pressure of 700 psia or less.

15. The method according to claim 14, wherein said pressure is 500 psia or less.

16. A method according to claim 14, wherein at least one compressor is located on the vehicle which allows for the addition of a low pressure source of natural gas to the tank containing an adsorbent and allows for the pressurization of the tank to the desired pressure.

17. The method according to claim 16, where said compressor is mechanically or electrically powered by the vehicle engine.

18. The method of claim 16, where the compressor can be powered by electricity when the car engine is not running.

19. The method of claim 18, wherein electricity is provided by a battery.

20. The method of claim 14, wherein a regulator is used to control delivery pressurized gas from the adsorbent tank to the engine while the engine is running.

21. The method according to claim 14, wherein upon filling the natural gas tank contains a quantity of natural gas that allows the car to run no more than 100 miles.

22. The method according to claim 14, wherein the adsorbent is selected from the group consisting of activated carbons, zeolites, metal organic frameworks and mixtures thereof.

23. A method operating a bi-fuel vehicle including a gasoline tank and a natural gas tank containing a natural gas adsorbent, the method comprising
(a) connecting a gas supply to a fill line on the vehicle, the fill line in flow communication with the natural gas tank and a compressor and filling the natural gas tank with natural gas to a pressure of 700 psia or less;
(b) driving the vehicle powered by the natural gas for a limited range of less than 100 miles, reducing the pressure in the tank; and
(c) refilling the natural gas tank by repeating step (a).

24. The method of claim 23, wherein the pressure in the natural gas tank drops to a value in the range of about 5 psia to about 20 psia before refilling the natural gas tank.
